(19) United States
(12) Patent Application Publication
(10) Pub. No.: US 2024/0405702 A1
(43) Pub. Date: Dec. 5, 2024

(54) APPARATUS AND METHOD FOR CONTROLLING PERMANENT MAGNET SYNCHRONOUS MOTOR, AND STORAGE MEDIUM STORING INSTRUCTIONS TO PERFORM METHOD FOR CONTROLLING PERMANENT MAGNET SYNCHRONOUS MOTOR

(71) Applicant: Research & Business Foundation SUNGKYUNKWAN UNIVERSITY, Suwon-si (KR)

(72) Inventors: Jae Wook JEON, Suwon-si (KR); Ton Hoang NGUYEN, Suwon-si (KR); Ty Trung NGUYEN, Suwon-si (KR); Sung Bhin OH, Suwon-si (KR); Youngsoo DO, Suwon-si (KR)

(73) Assignee: Research & Business Foundation SUNGKYUNKWAN UNIVERSITY, Suwon-si (KR)

(21) Appl. No.: 18/731,595

(22) Filed: Jun. 3, 2024

(30) Foreign Application Priority Data
Jun. 1, 2023 (KR) 10-2023-0071106

(51) Int. Cl. H02P 21/00; H02P 21/22

(52) U.S. Cl. CPC H02P 21/0007; H02P 21/22; H02P 2207/05

(57) ABSTRACT

There is provided an apparatus for controlling a permanent magnet synchronous motor in a permanent magnet synchronous motor system. The apparatus comprises a disturbance observation circuit unit configured to estimate concentrated disturbance of the permanent magnet synchronous motor using a nonlinear observation gain function; and a sliding mode controller configured to control the permanent magnet synchronous motor by reflecting the estimated concentrated disturbance in a position-current single-loop control in which back-stepping control and sliding mode control are integrated.

### CROSS-REFERENCE TO RELATED APPLICATION

This application claims the benefit under 35 USC 119 (a) of Korean Patent Application No. 10-2023-0071106, filed with the Korean Intellectual Property Office on Jun. 1, 2023, the disclosure of which is incorporated herein by reference in its entirety.

### TECHNICAL FIELD

The present disclosure relates to a motor control technology of a permanent magnet synchronous motor (PMSM) system.

This work was supported by Institute of Information & Communications Technology Planning & Evaluation (IITP) grant funded by the Korea government (MSIT; Ministry of Science and ICT) (No. 2021-0-01364, An intelligent system for 24/7 real-time traffic surveillance on edge devices).

### BACKGROUND

The permanent magnet synchronous motor is widely used as a motor for electric vehicles. The permanent magnet synchronous motor is consistently applied in the electric vehicle industry where durability and safety are key issues as there is no temperature increase due to the loss of a field coil. These permanent magnet synchronous motors are used in many industrial applications such as robotics, transportation, elevators, and machine tools due to their compact structure, high power density, high performance, and low losses, and controlled by field-oriented control technology widely used in high-performance motor drive control. Cascade proportional integral derivative (PID) control based on magnetic field-oriented control is used as a general and effective linear technique for regulating the permanent magnet synchronous motor due to its simplicity and stable performance at specific operating points. However, the permanent magnet synchronous motor suffers from the frequent distortion of motor control due to non-linearity, parameter uncertainty, and external disturbances when operating under various operating conditions, which can lead to undesirable dynamic responses. In this case, there is a limitation in ensuring the overall performance of the motor system using existing linear feedback control.

Therefore, there is a need for a method that can solve the shortcomings of existing linear controllers and maintain high dynamic performance of the motor drive.

### SUMMARY

One embodiment of the present disclosure proposes a motor control technology for a permanent magnet synchronous motor system that can convert a nonlinear control system into a reduced-order subsystem to solve problems such as distortion due to nonlinearity of the permanent magnet synchronous motor.

One embodiment of the present disclosure proposes a motor control technology for a permanent magnet synchronous motor system suitable for providing an adaptive convergence gain for back-stepping sliding mode control (BSMC) which combines back-stepping control and sliding mode control (SMC) to ensure robustness to disturbances and estimating unknown disturbances in order to reduce uncertainty parameters and external disturbance effects.

One embodiment of the present disclosure proposes a motor control technology for a permanent magnet synchronous motor system that can control speed and current with an existing single loop and overcome technical limitations with a constant observer gain.

The aspects of the present disclosure are not limited to the foregoing, and other aspects not mentioned herein will be clearly understood by those skilled in the art from the following description.

In accordance with an aspect of the present disclosure, there is provided an apparatus for controlling a permanent magnet synchronous motor in a permanent magnet synchronous motor system, the apparatus comprises: a disturbance observation circuit unit configured to estimate concentrated disturbance of the permanent magnet synchronous motor using a nonlinear observation gain function; and a sliding mode controller configured to control the permanent magnet synchronous motor by reflecting the estimated concentrated disturbance in a position-current single-loop control in which back-stepping control and sliding mode control are integrated.

Herein, the sliding mode controller may be configured to receive a signal including a reference current of a Direct-axis (D-axis) and reference position information of a rotor of the permanent magnet synchronous motor.

Additionally, the reference current of the D-axis may be set to 0.

Additionally, the sliding mode controller may be configured to control a current of a Quadrature-axis (Q-axis) and a current of the D-axis of the permanent magnet synchronous motor system.

Additionally, the disturbance observation circuit unit may be configured to calculate a derivative of the concerned disturbance and input the derivative to the sliding mode controller.

Additionally, the permanent magnet synchronous motor system may include a space vector pulse width modulator configured to convert a two-axis rotating system into a two-axis stationary system and determine a pulse width modulation signal for an inverter switch to generate a three-phase voltage required by the permanent magnet synchronous motor system.

Additionally, the back-stepping control may include a control for an adaptive convergence gain to prevent overshoot.

Additionally, the nonlinear observation gain function may include a nonlinear design function combining a primary state variable and a second state variable.

Additionally, the sliding mode controller may include an adaptive back-stepping sliding mode controlle.

Additionally, the disturbance observation circuit unit may include a nonlinear disturbance observer circuit unit.

In accordance with another aspect of the present disclosure, there is provided a method for controlling a permanent magnet synchronous motor in a permanent magnet synchronous motor system by a control unit in a permanent magnet synchronous motor system, the method comprises: calculating an adaptive convergence gain, position error, and a first virtual control signal by the control unit when an input signal is input to the permanent magnet synchronous motor in the permanent magnet synchronous motor system; calculating a first difference between the first virtual control signal and an actual control signal and calculating a second virtual control signal based on the first difference and a concentrated disturbance of the permanent magnet synchronous motor system estimated by a nonlinear disturbance observer circuit unit; calculating a second difference between the second virtual control signal and the actual control signal and calculating a first sliding-mode surface function and a voltage control signal of a Quadrature-axis (Q-axis) based on the second difference; and calculating a third difference between a third virtual control signal based on the voltage control signal of the Q-axis and the actual control signal and calculating a second sliding-mode surface function and a voltage control signal of a Direct-axis (D-axis) based on the third difference.

Herein, the input signal may include a reference current of the D-axis and reference position information of a rotor of the permanent magnet synchronous motor.

Additionally, the control unit may be configured to control a current of the Q-axis coordinate system and a current of the D-axis of the permanent magnet synchronous motor system.

Additionally, the nonlinear disturbance observation circuit unit may be configured to estimate the concentrated disturbance of the permanent magnet synchronous motor using nonlinear observation gain function, provide the concentrated disturbance of the permanent magnet synchronous motor system to the control unit, calculate a derivative of the concerned disturbance, and input the derivative of the concerned disturbance to the control unit.

Additionally, the permanent magnet synchronous motor system may include a space vector pulse width modulator configured to convert a two-axis rotating system into a two-axis stationary system and determine a pulse width modulation signal for an inverter switch to generate a three-phase voltage required by the permanent magnet synchronous motor system.

Additionally, the control unit may be configured to control the permanent magnet synchronous motor system by integrating back-stepping control and sliding mode control, and the back-stepping control may include a control for an adaptive convergence gain to prevent overshoot.

Additionally, the nonlinear observation gain function may include a nonlinear design function combining a primary state variable and a second state variable.

Additionally, the position error may be calculated by a difference between the reference position information and the actual control signal.

Additionally, the calculating the second virtual control signal may include calculating a nominal virtual control signal without considering uncertainty and an external load torque.

In accordance with another aspect of the present disclosure, there is provided a non-transitory computer readable storage medium storing computer executable instructions, wherein the instructions, when executed by a processor, cause the processor to perform a terminal control method, the terminal control method comprise: calculating an adaptive convergence gain, position error, and a first virtual control signal by the control unit when an input signal is input to the permanent magnet synchronous motor in the permanent magnet synchronous motor system; calculating a first difference between the first virtual control signal and an actual control signal and calculating a second virtual control signal based on the first difference and a concentrated disturbance of the permanent magnet synchronous motor system estimated by a nonlinear disturbance observer circuit unit; calculating a second difference between the second virtual control signal and the actual control signal and calculating a first sliding-mode surface function and a voltage control signal of a Quadrature-axis (Q-axis) based on the second difference; and calculating a third difference between a third virtual control signal based on the voltage control signal of the Q-axis and the actual control signal and calculating a second sliding-mode surface function and a voltage control signal of a Direct-axis (D-axis) based on the third difference.

According to one embodiment of the present disclosure, parameter uncertainty and external load torque disturbance are taken into consideration by accelerating an actual position to a target position while reducing overshoot in controlling the permanent magnet synchronous motor, a permanent magnet synchronous motor system including an adaptive convergence gain that improves nonlinear disturbance observation circuit unit (NDO) and maintains the robustness of an adaptive back-stepping sliding mode controller (ABSMC) is provided, and thus, position tracking control performance and robustness against disturbance can be further improved. Additionally, according to one embodiment of the present disclosure, the structure of the existing cascade type position controller can be simplified by integrating back-stepping control and SMC.

### BRIEF DESCRIPTION OF THE DRAWINGS

FIG. 1 is a block diagram for explaining a function of a motor control device of a permanent magnet synchronous motor system according to one embodiment of the present disclosure.

FIG. 2 is a detailed conceptual diagram of the motor control device of the permanent magnet synchronous motor system according to one embodiment of the present disclosure.

FIG. 3 is a flowchart for explaining the motor control method of the permanent magnet synchronous motor system according to one embodiment of the present disclosure.

FIG. 4 is a flowchart explaining a specific calculation process of Steps 1 to 3 of FIG. 3.

FIG. 5 is a flowchart explaining the specific calculation process of Step 4 in FIG. 3.

FIG. 6 is an image illustrating exemplary experimental devices used to test performance of the proposed disclosure.

FIGS. 7A and 7B are graphs illustrating a case where the proposed method was tested under a trapezoidal velocity motion profile.

FIGS. 8A to 8D are graphs illustrating experimental results in the motion profile of FIG. 7.

FIGS. 9A to 9F are graphs comparing results of PID+NDO, SMC+NDO, and ABSMC+NDO.

FIGS. 10A to 10F are performance comparison graphs when load torque suddenly occurs.

FIG. 11 is a graph illustrating the results of an experiment in a point-to-point position profile situation when using a fixed convergence gain.

FIG. 12 is a graph illustrating the results of an experiment in a point-to-point position profile situation with an external load torque.

FIGS. 13A to 13C are graphs illustrating the results of an experiment at a sinusoidal position profile of 10 sin (1.5 πt) with an external load torque of 0.12 Nm.

### DETAILED DESCRIPTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

Several nonlinear techniques have been developed to improve control performance of a motor system such as back-stepping control, adaptive control, fuzzy-logic control, sliding mode control, and model predictive control.

Among these methods, the back-stepping control is a systematic and recursive approach based on Lyapunov stability theory that guarantees overall asymptotic stability. The back-stepping control can transform complex nonlinear control systems into simple reduced-order subsystems. Using recursive design and virtual control variables, control laws can be derived for tracking the position or regulating the speed of a motor. However, because the back-stepping control is a strict model-based approach, the robustness of the permanent magnet synchronous motor drive cannot be guaranteed due to uncertainty and external disturbances. It is known that a back-stepping tracking controller with a load torque observer has been developed using machine parameter data from the permanent magnet synchronous motor, enabling precise control of a given reference trajectory.

The sliding mode control is a useful method in the permanent magnet synchronous motor because of the robustness to disturbances, fast response time, and simplicity of implementation. However, to ensure the robustness of SMC under parameter uncertainty and external disturbances, a switching gain greater than the upper limit of the concentrated disturbance is generally required, which may cause an undesirable chattering phenomenon. Several approaches have been introduced to solve the chattering problem, such as boundary layer approach, high-order SMC, a fuzzy sliding-mode, and a reaching law method.

Among these approaches, the reaching law method has been proven to be an effective strategy to reduce chattering. It directly affects the reaching process by modifying the control gain function to meet the requirements for robustness and chattering reduction. The control gain has a potentially large value in the reaching step, but has a small value in the sliding step, and when external disturbances occur, the robustness near the sliding-mode surface function decreases.

A combination of the SMC and the disturbance observation circuit unit is an effective way to further improve the robustness of the SMC-based reaching law method. The disturbance observation unit can estimate unknown disturbances (parameter variations, external disturbances, or the like) and transmit the disturbances to the SMC. Moreover, the switching gain needs to be smaller than an upper limit of the concerned disturbance and larger than the estimation error to reduce chattering.

In the disturbance observation unit, control of the motor controller is essential due to inevitability of uncertainty and external disturbance in the motor system. Several disturbance observation approaches, such as a Luenberger observer, a sliding mode observer, an extended state observer, or the like, have been proposed to improve the control system performance of motors. This illustrates that disturbance can be alleviated in the output by transmitting the estimated disturbance to the controller without affecting the performance of the system. Nonlinear disturbance observation (NDO) control methods have been actively studied recently because they are easy to implement and generate reliable disturbance estimation values. This technology has been tested in robots, converters, and motor drives and illustrates very powerful performance. However, since these studies used a fixed observer gain for the NDO, the observer may give a slower convergence rate in certain scenarios such as rapid changes in external load torque.

A composite method that combines the advantages of the back-stepping control and the SMC for permanent magnet synchronous motor speed regulation provides stable control performance, fast response, reduced position steady-state error, and robustness to disturbances unknown to the motor driver. However, BSMC can cause a large overshoot in the position step profile due to the fixed convergence gain of the back-stepping method.

Accordingly, in one embodiment of the present disclosure, adaptive BSMC (ABSMC) including an adaptive convergence gain is proposed.

The method proposed in the present disclosure can accelerate the actual position to the target position while reducing overshoot.

In one embodiment of the present disclosure, parameter uncertainty and external load disturbance are also considered, and a technique to improve NDO, maintain the robustness of ABSMC, and reduce steady-state errors is proposed.

Hereinafter, embodiments of the present disclosure will be described in detail with reference to the attached drawings.

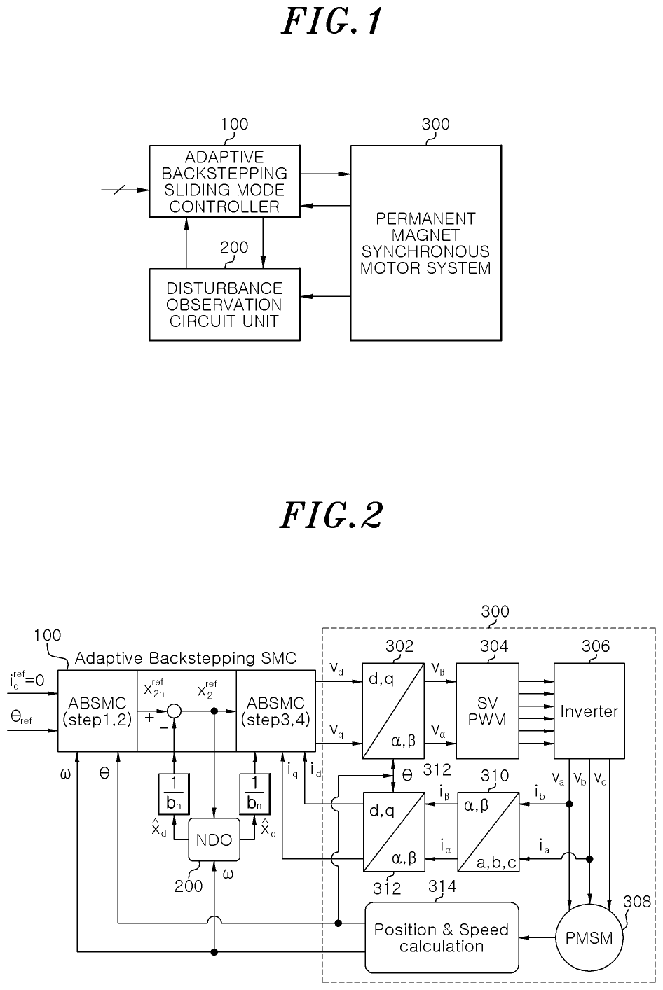

FIG. 1 is a block diagram illustrating the function of a motor control device of a permanent magnet synchronous motor system according to one embodiment of the present disclosure.

As illustrated in FIG. 1, the motor control device may include an adaptive back-stepping sliding mode controller 100 and a nonlinear disturbance observation unit 200, and the motor control device may be connected to a permanent magnet synchronous motor system 300. Of course, the motor control device may also be included in the permanent magnet synchronous motor system 300.

The adaptive back-stepping sliding mode controller 100 is formed with a position current single loop control structure that integrates back-stepping control and sliding mode control and may control the permanent magnet synchronous motor system 300.

The nonlinear disturbance observation unit 200 may estimate a concerned disturbance of the permanent magnet synchronous motor system 300 using a nonlinear observation gain function, and transmit the result of estimating the concerned disturbance to the adaptive back-stepping sliding mode controller 100.

FIG. 2 is a conceptual diagram to explain the specific function of the motor control device of FIG. 1, and illustrates a motor control structure of a permanent magnet synchronous motor system using a position-current single loop control structure.

In the motor control device of the permanent magnet synchronous motor system 300 according to one embodiment of the present disclosure, the inputs are the reference position θ_{ref} and a d-axis current, which are set to 0 so as to provide constant flux conditions in the permanent magnet synchronous motor system 300.

The control outputs are motor voltage supplies V_{q} and V_{d}. The adaptive back-stepping sliding mode controller 100 is a combination of the back-stepping and the SMC control, and the back-stepping includes an adaptive convergence gain to prevent a large overshoot. Additionally, in order to reduce the influence of uncertainty parameters and external disturbances, the nonlinear disturbance observation unit 200 estimates unknown disturbances and transfers the estimated disturbances to the adaptive back-stepping sliding mode controller 100 to maintain the robustness of the motor system.

The permanent magnet synchronous motor system 300 includes a first conversion unit 302, a space vector pulse width modulator 304, an inverter 306, a permanent magnet synchronous motor 308, a second conversion unit 310, a third conversion 312, and a position and velocity calculation unit 314.

The first conversion unit 302, for example, performs an inverse Park transform, and may convert two-axis rotating system components (V_{d}, V_{q}) transmitted from the adaptive back-stepping sliding mode controller 100 to two-axis stationary system components (V_{β}, V_{α}).

The space vector pulse width modulator 304 may determine the pulse width modulation signal for the inverter switch to generate the three-phase voltage required by the permanent magnet synchronous motor system 300.

The second conversion unit 310 may perform, for example, a Clarke transform and convert the three-phase system components (iₐ, i_{b}, i_{c}) into two-dimensional orthogonal system components (i_{α}, i_{β}).

The third conversion unit 312, for example, performs Park transform and may convert two-axis stationary system components (i_{α}, i_{β}) into two-axis rotating system components (i_{q}, i_{d}).

The position and velocity calculation unit 314 may measure the position feedback component (θ) and a velocity feedback component (ω=dθ/dt) using an encoder.

Meanwhile, the motor control device of the permanent magnet synchronous motor system according to the embodiment of the present disclosure can be divided into the design of the Q-axis current controller, the design of the D-axis current controller, and the design of the nonlinear disturbance observation unit.

### <Design of Q-axis Current Controller>

The position controller is designed to maintain the actual motor position accurately tracking the reference position x₀^{ref}=θ^{ref} under variations in internal parameters and external disturbances. To achieve this control goal, the position error e₀=x₀^{ref}−x₀ should be minimized.

Step 1: Select a candidate Lyapunov function as V₀=0.5e₀², then take the derivative of V_{q} with respect to time as illustrated in [Equation 1].

$${\dot{V}}_{0} = {e}_{0} {\dot{e}}_{0} = {e}_{0} ( {\dot{x}}_{0}^{r e f} - {\dot{x}}_{0} ) = {e}_{0} ( {\dot{x}}_{0}^{r e f} - {x}_{1} ) \qquad [ Equation 1 ]$$

In [Equation 1], the virtual control input is designed as illustrated in [Equation 2] below.

$${x}_{1}^{r e f} = {\dot{x}}_{0}^{r e f} + {c}_{0} {e}_{0} \qquad [ Equation 2 ]$$

C₀>0 is a strictly positive constant for the asymptotic convergence rate. Since V₀=−C₀e₀²≤0 is guaranteed, e₀ asymptotically converges to 0.

Step 2: Based on the value x₁^{ref} obtained in Step 1, determine the difference between x₁^{ref} and x₁ as e₁=x₁^{ref}−x₁. The second Lyapunov function is chosen as V₁=V₀+0.5e₁². The time derivative of V₁ is obtained as follows by [Equation 3].

$$\begin{matrix}{\dot{V}}_{1} = {\dot{V}}_{0} + {e}_{1} {\dot{e}}_{1} ( {\dot{x}}_{0}^{r e f} - {x}_{1} ) + {e}_{1} {\dot{e}}_{1} \\ = {e}_{0} ( {\dot{x}}_{0}^{r e f} + {e}_{1} - {x}_{1}^{r e f} ) + {e}_{1} {\dot{e}}_{1} \\ = {e}_{0} ( {e}_{1} - {c}_{0} {e}_{0} ) + {e}_{1} {\dot{e}}_{1} \\ = - {c}_{0} {e}_{0}^{2} + {e}_{1} ( {e}_{0} + {\dot{e}}_{1} )\end{matrix} \qquad [ Equation 3 ]$$

In [Equation 2], the ė₁ term is determined as follows by [Equation 4].

$${\dot{e}}_{1} = {\ddot{x}}_{0}^{r e f} + {c}_{0} ( {\dot{x}}_{0}^{r e f} - {x}_{1} ) + {a}_{n} {x}_{1} - {b}_{n} {x}_{2} - {x}_{d} = - {c}_{1} {e}_{1} \qquad [ Equation 4 ]$$

In [Equation 3] and [Equation 4], the term e₀+ė₁ is designed to be equal to −c₁e₁ with c₁>0.

$${e}_{0} + {\ddot{x}}_{0}^{r e f} + {c}_{0} ( {\dot{x}}_{0}^{r e f} - {x}_{1} ) + {a}_{n} {x}_{1} - {b}_{n} {x}_{2} - {x}_{d} = - {c}_{1} {e}_{1} \qquad [ Equation 5 ]$$

Then, the virtual control input may be determined as follows by [Equation 6].

$${x}_{2}^{r e f} = {x}_{2 n}^{r e f} - \frac{{x}_{d}}{{b}_{n}} \qquad [ Equation 6 ]$$

Here, x₂ₙ^{ref} is a nominal virtual control signal that does not consider uncertainty and external load torque, and is expressed as [Equation 7].

$${x}_{2 n}^{r e f} = \frac{1}{{b}_{n}} [ {e}_{0} + {\ddot{x}}_{0}^{r e f} + {c}_{0} ( {\dot{x}}_{0}^{r e f} - {x}_{1} ) + {a}_{n} {x}_{1} + {c}_{1} {e}_{1} ] \qquad [ Equation 7 ]$$

The positive gains c₀ and c₁ in [Equation 2] and [Equation 7] represent the convergence gains of the back-step controller. When this gain is large, the system has a faster response and better robustness, but causes a large overshoot in the step profile. Meanwhile, when the value of this gain is small, the system reacts slowly and overshoot decreases. Therefore, there is a trade-off between setup time and overshoot.

The present disclosure proposes an adaptive gain function to reduce a large overshoot and obtain fast settling time by adjusting the gain values c₀ and c₁ online. This is expressed as [Equation 8] below.

$${c}_{0} = {c}_{1} = \{ \begin{matrix}{c}_{initial} \\ {c}_{initial} - \vert {e}_{0} \vert ( 1 + λ {e}^{- η {\vert {e}_{0} \vert}^{\frac{1}{2}}} )\end{matrix} \qquad [ Equation 8 ]$$

$$if \vert {e}_{0} {e}_{1} \vert < δ$$

$$if \vert {e}_{0} {e}_{1} \vert > δ$$

Here, Cᵢₙᵢₜᵢₐₗ is the initial value of the convergence gain. δ>0 is an experimentally determined threshold. λ>0 and η>0. When the motor operates in a trapezoidal speed motion profile, |e₀e₁| is a small value, and c₀=Cᵢₙᵢₜᵢₐₗ. When the motor operates in the position step profile, |e₀e₁| is an excessively large value, and to reduce a large overshoot

$${c}_{0} = {c}_{initial} - \vert {\dot{e}}_{0} \vert ( 1 + λ {e}^{- η {\vert {e}_{0} \vert}^{\frac{1}{2}}} ) .$$

Step 3: Based on the value x₂^{ref} obtained in Step 2 above, the difference between x₂^{ref} and x₂ is determined as e₂=x₂^{ref}−x₂. In this step, sliding mode control is used to design the voltage supply vg of the motor, and the procedure is separated into two parts: sliding-mode surface function and reaching law method.

First, the sliding-mode surface function is designed as [Equation 9] below based on the error e₂ and an integral thereof.

$${S}_{1} = {e}_{2} \qquad [ Equation 9 ]$$

Considering the Lyapunov function V₂=V₁+0.557, the derivative of V₂ with respect to time is determined as follows by [Equation 10].

$$\begin{matrix}{\dot{V}}_{2} = {e}_{0} {\dot{e}}_{0} + {e}_{1} {\dot{e}}_{1} + {S}_{1} {\dot{S}}_{1} \\ = {e}_{0} ( {e}_{1} - {c}_{0} {e}_{0} ) + {e}_{1} ( {\dot{x}}_{1}^{r e f} - {\dot{x}}_{1} ) + {S}_{1} {\dot{S}}_{1}\end{matrix} \qquad [ Equation 10 ]$$

The term (x₁^{ref}˜x₁) in [Equation 6] and [Equation 7] is calculated as follows by [Equation 11].

$$\begin{matrix}{\dot{x}}_{1}^{r e f} - {\dot{x}}_{1} = {\dot{x}}_{1}^{r e f} + {a}_{n} {x}_{1} - {b}_{n} {x}_{2} - {x}_{d} \\ = {\dot{x}}_{1}^{r e f} + {a}_{n} {x}_{1} - {b}_{n} ( {x}_{2}^{r e f} - {e}_{2} ) - {x}_{d} \\ = {\dot{x}}_{1}^{r e f} + {a}_{n} {x}_{1} - {b}_{n} {x}_{2 n}^{r e f} + {b}_{n} {e}_{2} \\ = - {e}_{0} - {c}_{1} {e}_{1} + {b}_{n} {e}_{2}\end{matrix} \qquad [ Equation 11 ]$$

If [Equation 11] is replaced with [Equation 10], V₂ can be rewritten as [Equation 12].

$${\dot{V}}_{2} = - {c}_{0} {e}_{0}^{2} - {c}_{1} {e}_{1}^{2} + {b}_{n} {e}_{1} {e}_{2} + {S}_{1} {\dot{S}}_{1} \qquad [ Equation 12 ]$$

The constant proportional speed reaching law method for sliding mode is designed as follows by [Equation 13].

$${\dot{S}}_{1} = - {k}_{1} sgn ( {S}_{1} ) - {k}_{2} {S}_{1} - {b}_{n} {e}_{1} ; {k}_{1} , {k}_{2} > 0 \qquad [ Equation 13 ]$$

Therefore, the resulting control system is asymptotically stable V₂=−c₀e₂−C₁e₂−k₁S₁sgn(S₁)−k₂S₁²≤0.

When the derivative of S₁ in [Equation 9] is obtained, it is expressed as follows in [Equation 14].

$${\dot{S}}_{1} = {\dot{e}}_{2} \qquad [ Equation 14 ]$$

The derivative of e₂ with respect to time is determined as follows by [Equation 15].

$${\dot{e}}_{2} = {\dot{x}}_{2}^{r e f} - {\dot{x}}_{2} = {\dot{x}}_{2 n}^{r e f} - \frac{{\dot{x}}_{d}}{{b}_{n}} - {\dot{x}}_{2} \qquad [ Equation 15 ]$$

Here, the nominal virtual control signal is equal to [Equation 16].

$${\dot{x}}_{2 n}^{r e f} = {b}_{n}^{- 1} [ {\dot{e}}_{0} + {\ddot{x}}_{0}^{r e f} + {c}_{0} {\ddot{x}}_{0}^{r e f} + ( {a}_{n} - {c}_{0} ) {\dot{x}}_{1} + {c}_{1} {\dot{e}}_{1} ] \qquad [ Equation 16 ]$$

When [Equation 4] is replaced with [Equation 16], the following becomes [Equation 17].

$${\dot{x}}_{2 n}^{r e f} = {h}_{q} ( x ) - {k}_{a c} {x}_{d} \qquad [ Equation 17 ]$$

Here, h_{q}(x)=bₙ⁻¹ [\ddot{x}₀^{ref}+(c₀+c₁)\ddot{x}₀^{ref}+(1+c₀c₁)(\ddot{x}₀^{ref}−x₁)−(c₀+c₁−aₙ)(−aₙx₁+bₙx₂)] and k_{ac}=(c₀+c₁−aₙ)bₙ⁻¹.

From [Equation 13] to [Equation 17], \dot{S}₁ is derived as illustrated in [Equation 18] below.

$${\dot{S}}_{1} = {h}_{q} ( x ) - {k}_{a c} {x}_{d} - \frac{{\dot{x}}_{d}}{{b}_{n}} - {f}_{q} ( x ) - {b}_{q} {v}_{q} = - {k}_{1} sgn ( {S}_{1} ) - {k}_{2} {S}_{1} - {b}_{n} {e}_{1} \qquad [ Equation 18 ]$$

In [Equation 18], the voltage supply to the q-axis can be derived as follows by [Equation 19].

$${v}_{q} = {b}_{q}^{- 1} [ {h}_{q} ( x ) - {k}_{ac} {x}_{d} - \frac{{\dot{x}}_{d}}{{b}_{n}} - {f}_{q} ( x ) + {k}_{1} sgn ( {S}_{1} ) + {k}_{2} {S}_{1} + {b}_{n} {e}_{1} ] \qquad [ Equation 19 ]$$

x₂^{ref} is calculated in [Equation 6] and the control signal V_{q} is calculated in [Equation 19], and a concerned disturbance x_{d} and a derivative thereof \dot{x}_d which can cause unwanted dynamic responses in an unknown PMSM system are included. The concerned disturbance x_{d} and the derivative thereof \dot{x}_d are estimated by providing feedforward compensation to the controller using NDO. More details are provided in the design of the nonlinear disturbance observation section below.

### <D-axis Current Controller Design>

Step 4: This step designs the control signal V_{d} so that the d-axis current output from the motor track is the reference current i_{d}^{ref}=x₃^{ref}. (As mentioned above, i_{d}^{ref}=0 gives constant flux.) To achieve this goal, the difference e₃=0−x₃ must be minimized. As in Step 3, the SMC is used to design the control signal V_{d}. The sliding surface is designed as follows by [Equation 20].

$${S}_{2} = {e}_{3} + {α}_{2} {\int }_{0}^{t} {e}_{3} ( τ ) d τ \qquad [ Equation 20 ]$$

Here a₂>0, and the control signal V_{d} is derived using the reaching law method.

$${\dot{S}}_{2} = - {k}_{3} sgn ( {S}_{2} ) - {k}_{4} {S}_{2} ; {k}_{3} , {k}_{4} > 0 \qquad [ Equation 21 ]$$

Finding the derivative of S₂ in [Equation 18] is performed as follows in [Equation 22].

$${\dot{S}}_{2} = {\dot{e}}_{3} + {α}_{2} {e}_{3} = - {f}_{d} ( x ) - {b}_{d} {v}_{d} + {α}_{2} {e}_{3} \qquad [ Equation 22 ]$$

From [Equation 21] and [Equation 22], the control signal V_{d} can be calculated as [Equation 23].

$${v}_{d} = {b}_{d}^{- 1} [ - {f}_{d} ( x ) + {α}_{2} {e}_{3} + {k}_{3} sgn ( {S}_{2} ) + {k}_{4} {S}_{2} ] \qquad [ Equation 23 ]$$

According to the Lyapunov function definition V₃=0.5S₂², V₃=−k₃S₂sgn (S₂)−k₄S₂≤0 can be guaranteed. Therefore, the value of x₃ converges to 0.

### <Design of Nonlinear Disturbance Observer Circuit Unit>

It can be considered that uncertainty and external disturbance are included along with the virtual control x₂^{ref} obtained in Step 2.

$${\dot{x}}_{1} = - {a}_{n} {x}_{1} + {b}_{n} {x}_{2}^{ref} + {x}_{d} \qquad [ Equation 24 ]$$

The nonlinear disturbance observation unit is designed as follows by [Equation 25].

$$\{ \begin{matrix}{\hat{x}}_{d} = z + p ( {x}_{1} ) \\ \dot{z} = l ( {x}_{1} ) [ {a}_{n} {x}_{1} - {b}_{n} {x}_{2}^{ref} - ( z + p ( {x}_{1} ) ) ]\end{matrix} \qquad [ Equation 25 ]$$

Here,

$$\frac{\partial p ( {x}_{1} )}{\partial {x}_{1}} = l ( {x}_{1} )$$

is an observer gain function. An observer error e_{d}=x_{d}−\hat{x}_{d}, ė_{d} is obtained as illustrated in [Equation 26] below.

$$\begin{matrix}{\dot{e}}_{d} = {\dot{x}}_{d} - {\dot{\hat{x}}}_{d} = {\dot{x}}_{d} - \dot{z} - \dot{p} ( {x}_{1} ) \\ = {\dot{x}}_{d} - l ( {x}_{1} ) [ {a}_{n} {x}_{1} - {b}_{n} {x}_{2}^{ref} - ( z + p ( {x}_{1} ) ) ] - \dot{p} ( {x}_{1} ) \\ = {\dot{x}}_{d} - l ( {x}_{1} ) [ {a}_{n} {x}_{1} - {b}_{n} {x}_{2}^{ref} - {\hat{x}}_{d} ] - \dot{p} ( {x}_{1} ) \\ = {\dot{x}}_{d} - l ( {x}_{1} ) [ {x}_{d} - {\dot{x}}_{1} - {\hat{x}}_{d} ] - \dot{p} ( {x}_{1} ) \\ = {\dot{x}}_{d} - l ( {x}_{1} ) [ {x}_{d} - {\dot{x}}_{1} - {\hat{x}}_{d} ] - \frac{\partial p ( {x}_{1} )}{\partial {x}_{1}} . \frac{\partial {x}_{1}}{\partial t} \\ = {\dot{x}}_{d} - l ( {x}_{1} ) [ {x}_{d} - {\dot{x}}_{1} - {\hat{x}}_{d} ] - l ( {x}_{1} ) . \dot{x} - 1 \\ = {\dot{x}}_{d} - l ( {x}_{1} ) [ {x}_{d} - {\hat{x}}_{d} ] \\ = {\dot{x}}_{d} - l ( {x}_{1} ) [ {e}_{d} ]\end{matrix} \qquad [ Equation 26 ]$$

Generally, the observer gain is selected as a fixed constant value L₁>0, and the function p(x₁)=L₁x₁ is designed as a linear function (LDO) to estimate the disturbance. The derivative of the observer error is ė_{d}=\dot{x}_{d}−L₁e_{d}. The observer error is given in [Equation 18]

$$\vert {e}_{d} ( t ) \vert \leq \vert {e}_{d ( 0 )} \vert {e}^{- {L}_{1} t} + \frac{ε}{{L}_{1}} \qquad [ Equation 27 ]$$

Here, |\dot{x}_{d}|<ε is the boundary of concerned disturbance x_{d}.

In [Equation 27], when the system has a constant concerned disturbance \dot{x}_{d}=0 (which means that ε=0), the observer error means that e_{d} converges to 0, meaning that the disturbance observation circuit unit can accurately estimate the concerned disturbance. In the steady state, when the concerned disturbance changes slowly and the derivative of the disturbance is limited by ε, the observer error 37 is asymptotically and exponentially stable with respect to the initial error e_{d} (0), while the steady-state error ε/L₁ depends on the value of L₁. The larger the observer gain, the smaller the observer error e_{d} and the faster the disturbance estimate response. The fixed observer gain may cause the observer to provide a slower convergence rate in some critical scenarios such as rapid changes in the external load torque.

The present disclosure proposes a nonlinear design function p(x₁) as illustrated in Equation 29 (NDO).

$$p ( {x}_{1} ) = {L}_{1} {x}_{1} + {L}_{2} {x}_{1}^{2} sgn ( {x}_{1} ) \qquad [ Equation 29 ]$$

Here L₁ and L₂>0 are constant parameters. Unlike the fixed gain designed in [Equation 15] to [Equation 17], the proposed NDO uses a nonlinear design function p(x₁) that combines a primary state variable and a secondary state variable. Differentiating the nonlinear function p(x₁) with respect to x₁ yields the following [Equation 30].

$$l ( {x}_{1} ) = {L}_{1} + 2 {L}_{2} {x}_{1} sgn ( {x}_{1} ) \geq {L}_{1} \qquad [ Equation 30 ]$$

The observer gain observer gain l(x₁) is configured to satisfy a global exponential stability condition of the observer error in [Equation 26]. It is clear that the proposed l(x₁) has a larger size compared to the constant gain L₁ used in [Equation 15] to [Equation 17]. As a result, the nonlinear gain l(x₁) can provide faster convergence speed while reducing observer error.

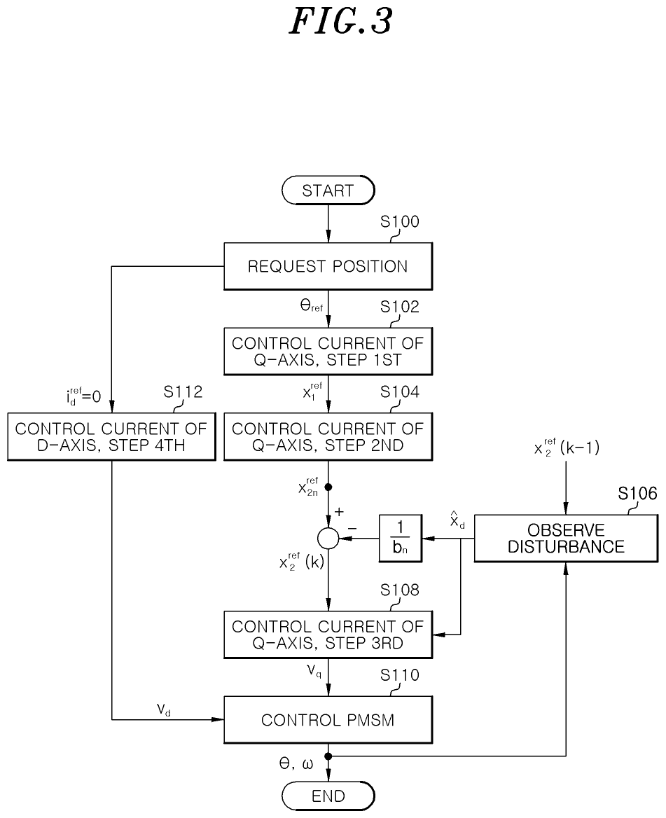

FIG. 3 illustrates a position control algorithm using adaptive back-stepping sliding mode control and nonlinear disturbance observation, which is the “Q-axis current control” block corresponding to the Q-axis current control design described in FIG. 2.

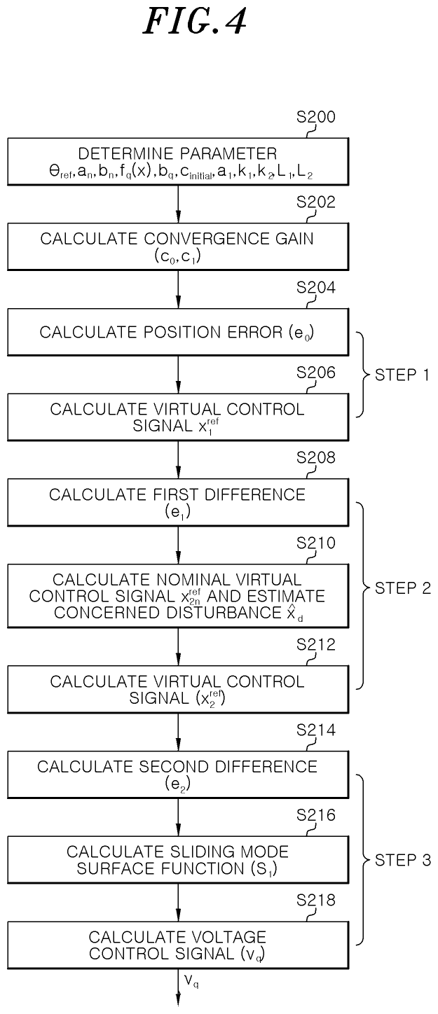

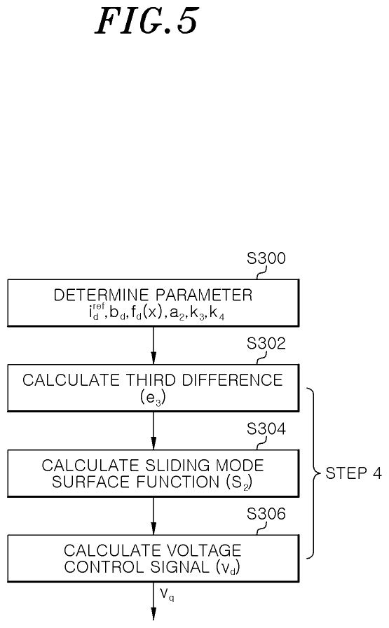

Specifically, FIG. 4 illustrates a step-by-step implementation process of the Q-axis current controller for calculating a voltage control signal V_{q} to be supplied to the motor, and FIG. 5 illustrates a step-by-step implementation process of the D-axis current controller to calculate a voltage control signal V_{d} to be supplied to the motor.

The proposed method combines two techniques, that is, the adaptive back-stepping sliding mode control and the nonlinear disturbance observation.

The adaptive back-stepping sliding control is a position-current single-loop control structure that simplifies the existing cascade position controller structure by integrating both the back-stepping control and SMC. A complex adaptive back-stepping sliding mode control provides the asymptotic stability of the back-stepping control and the robustness and rapid convergence of the SMC. The adaptive back-stepping sliding mode control also includes an adaptive law to adjust a back-stepping convergence gain, which can be used to prevent large overshoots in point-to-point positioning instructions.

The nonlinear disturbance observation unit uses an improved nonlinear observer gain function to estimate concerned disturbances in the permanent magnet synchronous motor system and reduce steady-state errors.

The combination of the adaptive back-stepping sliding mode control and the nonlinear disturbance observation can improve control performance in terms of fast transient response, robustness, and small steady-state error compared to PID and SMC position control methods.

### <Mathematical Model of Permanent Magnet Synchronous Motor>

FIG. 2 illustrates the control structure of the permanent magnet synchronous motor system using the position-current single loop control structure. In this method, the input is the reference position θ_{ref} and the d-axis current set to zero to provide constant flux conditions in a permanent magnet synchronous motor, and the control outputs are the voltage supplies V_{q} and V_{d} of the motor. The adaptive back-stepping sliding mode controller is a combination of the backstep and SMC control and the backstep includes an adaptive convergence gain to prevent a large overshoot. Additionally, in order to reduce the uncertainty parameter and the influence of external disturbances, the nonlinear disturbance observation circuit unit is used with some modifications in the observer gain design to estimate the unknown disturbances and pass the estimated unknown disturbances to the adaptive back-stepping sliding mode controller to maintain the robustness of the motor system.

The mathematical model of the permanent magnet synchronous motor system in a rotor d-q reference frame can be expressed as follows in [Equation 31], [Equation 32], and [Equation 33].

$$\frac{{di}_{d}}{dt} = \frac{1}{{L}_{d}} ( {v}_{d} - {Ri}_{d} + P . {L}_{q} . ω . {i}_{q} ) \qquad [ Equation 31 ]$$

$$\frac{{di}_{q}}{dt} = \frac{1}{{L}_{q}} ( {v}_{q} - {Ri}_{q} - P . {L}_{q} . ω . {i}_{d} ) \qquad [ Equation 32 ]$$

$${T}_{e} = 1.5 P [ {ψ}_{f} {i}_{q} + ( {L}_{d} - {L}_{q} ) {i}_{q} {i}_{d} ] \qquad [ Equation 33 ]$$

The items of [Equation 31], [Equation 32], and [Equation 33] may be defined as follows.
V_{d} and V_{q}: stator voltage in d-q frame
i_{d} and i_{q}: current in d-q frame
R: stator resistance
L_{d} and L_{q}: stator inductance in d-q frame
F: number of rotor pole pairs
ψ_{f}: flux linkage of rotor permanent magnet
ω: rotor angular velocity
Tₑ: electromagnetic torque

Since the d-axis current is set to 0, the permanent magnet linkage ψ_{f} is a constant value. Therefore, the torque Tₑ depends only on the q-axis current and can be simplified as follows by [Equation 34].

$${T}_{e} = 1.5 P {ψ}_{f} {i}_{q} = {K}_{t} . {i}_{q} \qquad [ Equation 34 ]$$

In fact, the equation of motion of the motor can be expressed by the influence of internal parameter changes and external load torque as illustrated in [Equation 35], [Equation 36], and [Equation 37] below.

$$\frac{d θ}{dt} = ω \qquad [ Equation 35 ]$$

$${T}_{e} = J \frac{d ω}{dt} + B ω + {T}_{L} \qquad [ Equation 36 ]$$

$$\begin{matrix}⇔ {T}_{e} = ( {J}_{n} + Δ J ) \frac{d ω}{dt} + ( {B}_{n} + Δ B ) ω + {T}_{L} \\ = {J}_{n} \frac{d ω}{dt} + {B}_{n} ω + d\end{matrix} \qquad [ Equation 37 ]$$

The items of [Equation 35], [Equation 36], and [Equation 37] can be defined as follows.
Kₜ: torque constant
J: total moment of inertia of rotor and load
B: actual coefficient of friction
T_{L}: external load torque that can be considered as external disturbance
Jₙ and Bₙ: nominal parameters; ΔJ and ΔB are parameter changes
d(t)=(ΔJdω/dt+ΔB·ω+T_{L} represents a concerned disturbance including internal parameter fluctuations and external load disturbance.

To facilitate controller design, [Equation 35], [Equation 37], [Equation 32], and [Equation 31] are collected and rewritten as [Equation 38] to [Equation 41] below, respectively.

$$\\ \begin{matrix}{\dot{x}}_{0} = {x}_{1} & [ Equation 38 ]\end{matrix}$$

$$\\ \begin{matrix}{\dot{x}}_{1} = - {a}_{n} {x}_{1} + {b}_{n} {x}_{2} + {x}_{d} & [ Equation 39 ]\end{matrix}$$

$$\\ \begin{matrix}{\dot{x}}_{2} = {f}_{q} ( x ) + {b}_{q} {v}_{q} & [ Equation 40 ]\end{matrix}$$

$$\\ \begin{matrix}{\dot{x}}_{3} = {f}_{d} ( x ) + {b}_{d} {v}_{d} & [ Equation 41 ]\end{matrix}$$

Here, x₀=0, x₁=ω, x₂=i_{q} and x₃=i_{d} are measurable variables, and

$$\\ {x}_{d} = - \frac{d}{{J}_{n}}$$

is a lumped disturbance and an unknown value.

$$\\ {a}_{n} = \frac{{B}_{n}}{{J}_{n}} , {b}_{n} = \frac{{K}_{t}}{{J}_{n}} , {f}_{q} ( x ) = - \frac{1}{{L}_{q}} ( {Ri}_{q} + P ω {L}_{d} {i}_{d} + \frac{2}{3} {K}_{t} ω ) , {b}_{q} = \frac{1}{{L}_{q}} ;$$

$$\\ {f}_{d} ( x ) = \frac{1}{{L}_{d}} ( P ω {L}_{q} {i}_{q} - {Ri}_{d} ) and {b}_{3} = \frac{1}{{L}_{d}} .$$

[Equation 38] to [Equation 40] were used to configure the Q-axis current control step (Steps S102, S104, and S108 in FIG. 3), and [Equation 41] was used to configure the D-axis current control step (Step S112 in FIG. 3).

Hereinafter, the motor control method of the permanent magnet synchronous motor system combining the adaptive back-stepping sliding mode control and the nonlinear disturbance observation according to one embodiment of the present disclosure will be described in more detail with reference to the attached FIGS. 4 and 5.

First, the embodiment of FIG. 4 proposes a step-by-step procedure for designing the q-axis current control and the d-axis current control to calculate the control voltage supply of the motor V_{q} and V_{d} at each sampling time.

Step 1: calculate adaptive convergence gains c₀ and c₁ as illustrated in [Equation 42] (S202). When starting a process, errors e₀ and e₁ are initialized to 0.

$$\\ \begin{matrix}{c}_{0} = {c}_{1} = \{ \begin{matrix}{c}_{initial} \\ {c}_{initial} - \vert {\dot{e}}_{0} \vert ( 1 + λ {e}^{{}_{} - η {\vert {e}_{0} \vert}^{\frac{1}{2}}} )\end{matrix} & [ Equation 42 ]\end{matrix}$$

$$\\ if \vert {e}_{0} {e}_{1} \vert < δ if \vert {e}_{0} {e}_{1} \vert < δ$$

Step 2: calculate position error e₀=θ^{ref}−x₀ (S204).

Step 3: calculate virtual control signal x₁^{ref} as input of [Equation 39] as illustrated in [Equation 43] (S206).

$$\\ \begin{matrix}{x}_{1}^{{}_{} ref} = \dot{x} {}_{0}^{{}_{} ref} + {c}_{0} {e}_{0} & [ Equation 43 ]\end{matrix}$$

Step 4: calculate the difference between x₁^{ref} and x₁:e₁=x₁^{ref}−x₁ (S208).

Step 5: calculate nominal virtual control signal x₂ₙ^{ref} as follows by [Equation 44] without considering uncertainty and external load torque (S210).

$$\\ \begin{matrix}{x}_{2 n}^{{}_{} ref} = \frac{1}{{b}_{n}} [ {e}_{0} + \ddot{x} {}_{0}^{{}_{} ref} + {c}_{0} ( \dot{x} {}_{0}^{{}_{} ref} - {x}_{1} ) + {a}_{n} {x}_{1} + {c}_{1} {e}_{1} ] & [ Equation 44 ]\end{matrix}$$

Step 6: estimate concerned disturbance \hat{x}_{d} and the derivative thereof \hat{x}_{d}, and calculate p(x₁) as illustrated in [Equation 45].

$$\\ \begin{matrix}p ( {x}_{1} ) = {L}_{1} {x}_{1} + {L}_{2} {x}_{1}^{{}_{} 2} sgn ( {x}_{1} ) & [ Equation 45 ]\end{matrix}$$

In addition, the observer gain l(x₁) is calculated as follows by [Equation 46].

$$\\ \begin{matrix}l ( {x}_{1} ) = {L}_{1} + 2 {L}_{2} {x}_{1} sgn ( {x}_{1} ) & [ Equation 46 ]\end{matrix}$$

Additionally, the concerned disturbance \hat{x}_{d} is estimated as follows by [Equation 47].

$$\\ \begin{matrix}\{ \begin{matrix}{\hat{x}}_{d} = z + p ( {x}_{1} ) \\ \dot{z} = l ( {x}_{1} ) [ {a}_{n} {x}_{1} - {b}_{n} {x}_{2}^{{}_{} ref} - ( z + p ( {x}_{1} ) ) ]\end{matrix} & [ Equation 47 ]\end{matrix}$$

In addition, the derivative

$$\\ {{x}^{\dot{\hat{}}}}_{d} = \frac{d {\hat{x}}_{d}}{dt}$$

or concerned disturbance is calculated.

Step 7: calculate virtual control signal x₂^{ref} as the input of [Equation 40] as illustrated in [Equation 48] (S212).

$$\\ \begin{matrix}{x}_{2}^{{}_{} ref} = {x}_{2 n}^{{}_{} ref} - \frac{{\hat{x}}_{d}}{{b}_{n}} & [ Equation 48 ]\end{matrix}$$

Step 8: calculate the difference between x₂^{ref} and x₂:e₂=x₂^{ref}−x₂ (S214).

Step 9: Calculate the sliding-mode surface function S_1 as illustrated in [Equation 49] (S216).

$$\\ \begin{matrix}{S}_{1} = {e}_{2} & [ Equation 49 ]\end{matrix}$$

Step 10: calculate voltage control signal v, as illustrated in [Equation 50] (S218).

$$\\ \begin{matrix}{h}_{q} ( x ) = {b}_{n}^{{}_{} - 1} [ \begin{matrix}{x}^{…} {}_{0}^{{}_{} ref} + ( {c}_{0} + {c}_{1} ) \ddot{x} {}_{0}^{{}_{} ref} + ( 1 + {c}_{0} {c}_{1} ) ( \dot{x} {}_{0}^{{}_{} ref} - {x}_{1} ) - \\ ( {c}_{0} + {c}_{1} - {a}_{n} ) ( - {a}_{n} {x}_{1} + {b}_{n} {x}_{2} )\end{matrix} ] & [ Equation 50 ]\end{matrix}$$

$$\\ {k}_{ac} = ( {c}_{0} + {c}_{1} - {a}_{n} ) {b}_{n}^{{}_{} - 1}$$

$$\\ {v}_{q} = {b}_{q}^{{}_{} - 1} [ {h}_{q} ( x ) - {k}_{ac} {\hat{x}}_{d} - \frac{{{x}^{\dot{\hat{}}}}_{d}}{{b}_{n}} - {f}_{q} ( x ) + {k}_{1} sgn ( {S}_{1} ) + + {k}_{2} {S}_{1} + {b}_{n} {e}_{1} ]$$

Step 11: calculate the difference between x₃^{ref} and x₃:e₃=x₃^{ref}−x₃ (S302).

Step 12: calculate sliding surface S₂ for D-axis current controller as illustrated in [Equation 51] (S304).

$$\\ \begin{matrix}{S}_{2} = {e}_{3} + {α}_{2} {\int }_{0}^{t} {e}_{3} ( τ ) d τ & [ Equation 51 ]\end{matrix}$$

Step 13: calculate voltage control signal V_{d} as illustrated in [Equation 52] (S306).

$$\\ \begin{matrix}{v}_{d} = {b}_{d}^{{}_{} - 1} [ - {f}_{d} ( x ) + {α}_{2} {e}_{3} + {k}_{3} sgn ( {S}_{2} ) + {k}_{4} {S}_{2} ] & [ Equation 52 ]\end{matrix}$$

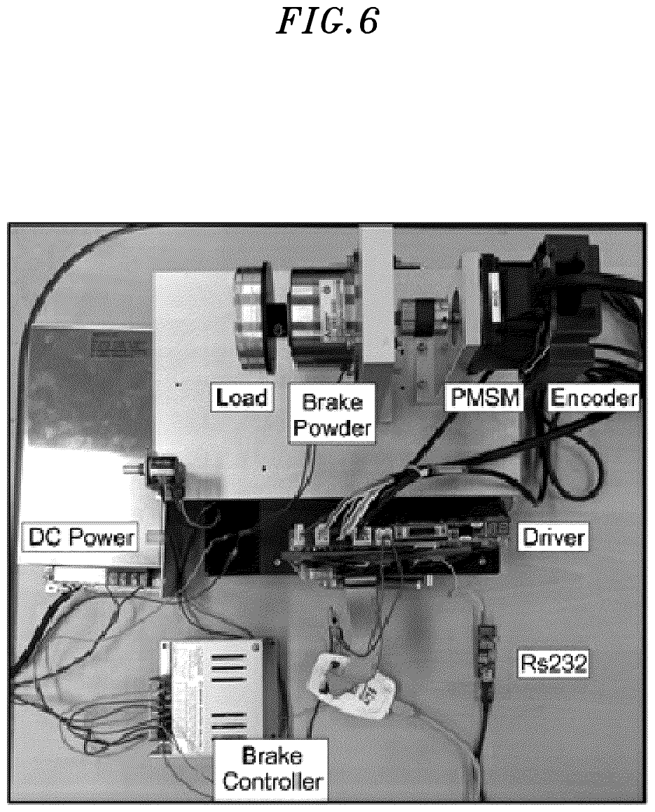

FIG. 6 exemplarily illustrates experimental devices used to test the performance of the proposed disclosure.

This setup consists of a PMSM attached to an incremental encoder of 2500 lines or 10000 pulses/revolution to measure the position and speed of a motor shaft. A ZKG-20AN powder clutch of Mitsubishi is mounted coaxially on the motor shaft to generate external load torque T₂, and CTA3200 brake controller of OGURA CLUTCH is used to adjust the current applied to the powder brake.

The motor is driven by a field-oriented control board integrated with an ARM CortexM4 core (STM32F446VC) to implement all current and speed control loops for the PMSM system. All experimental results were transmitted to the computer through RS232 communication connected to the driver module, recorded data for debugging, and plotted the results using MATLAB software. The parameters of PMSM are listed in Table 1 below.

TABLE 1

| Parameter | Value | |
|---|---|---|
| Rate voltage | 24 | V |
| Rate Speed | 2500 | rpm |
| Torque constant | 0.0613 | N · m/A |
| L_{d}, L_{q} | 1.13 | mH |
| Bₙ | 1.2 × 10⁻³ | kg · m2/s |
| Limited current | ±6.5 | A |
| Encoder Lines | 2500 | PPR |
| Pole pairs | 5 | |
| R | 1.4 | Ω |
| Jₙ | 54.2 × 10⁻⁶ | kg · m2 |

In the present disclosure, the combined effect of the adaptive back-stepping sliding mode control (hereinafter referred to as ABSMC) and the nonlinear disturbance observation (hereinafter referred to as NDO) which were the proposed methods was compared with the PID+NDO and SMC+NDO methods. To ensure a fair comparison between the proposed method and other methods, experiments were conducted under the same conditions.

To obtain the best possible system response for each technique, the PID, SMC, and controller parameters for the proposed method were iteratively adjusted to select appropriate parameters through trial and error.

The relevant parameters of the three control methods are as follows.

First, the parameters for the nonlinear observer gain are L₁=900 and L₂=17. The PID and SMC position controls are based on a cascade control structure. The position controls include d and q internal PI current controllers. For PID and SMC experiments, the control gains of two PI controllers for the d- and q-axis current loops are configured using the elimination method. The cutoff frequency of current control is 1000 Hz and the current control gain is kₚ=7 and kₜ=8796.

In addition, the parameters for PID control are k_{p;pos}=64.5, k_{i;pos}=738, and k_{d;pos}=1. The SMC position control with the sliding surface S₃=ė₀+C₃e₀ and the reaching law method \dot{S}₃=−k₅sgn(S₃)−k₆S₃ was designed with the parameter c₃=300. k₅=15 and k₆=30. The sampling frequency of the current loop is 20 kHz and the position control loop is 2 kHz. The parameters of ABSMC are Cᵢₙᵢₜᵢₐₗk₆=30=180, a₁=a₂=800, k₁=k₃=170, and k₂=k₄=250. The adaptation parameters for ABSMC are λ=2.5, and η=0.5 and threshold δ=2.

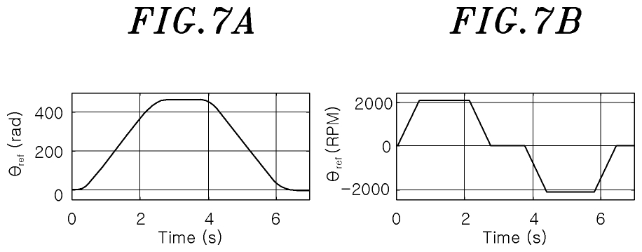

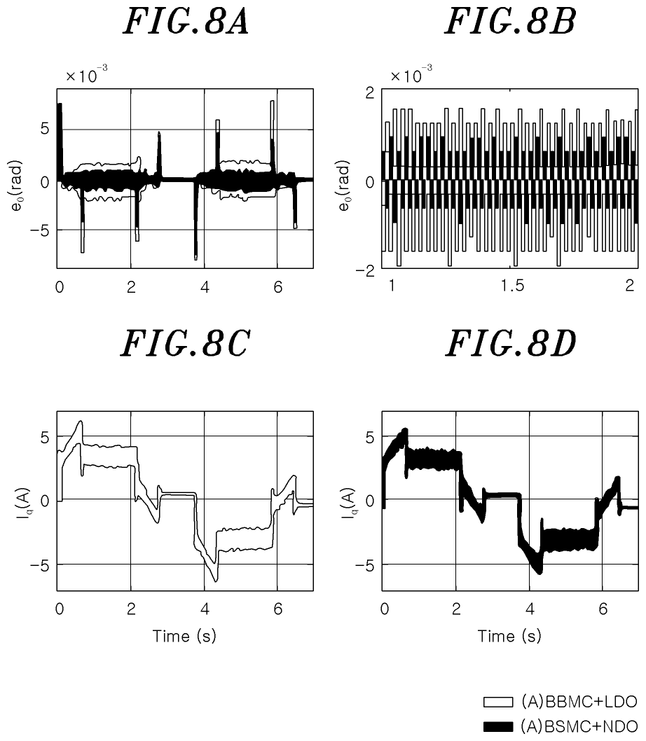

FIGS. 8A to 8D illustrate the performance of the proposed ABSMC+NDO for the position control when considering the uncertainty and external load torque, and the actual inertia of the system is J=Jₙ+ΔJ=111×10⁻⁶ kg·m². In order to demonstrate the effectiveness of the proposed method, the present disclosure tested the proposed method under the trapezoidal velocity motion profile, step profile, and sinusoidal profile as illustrated in FIGS. 7A and 7B.

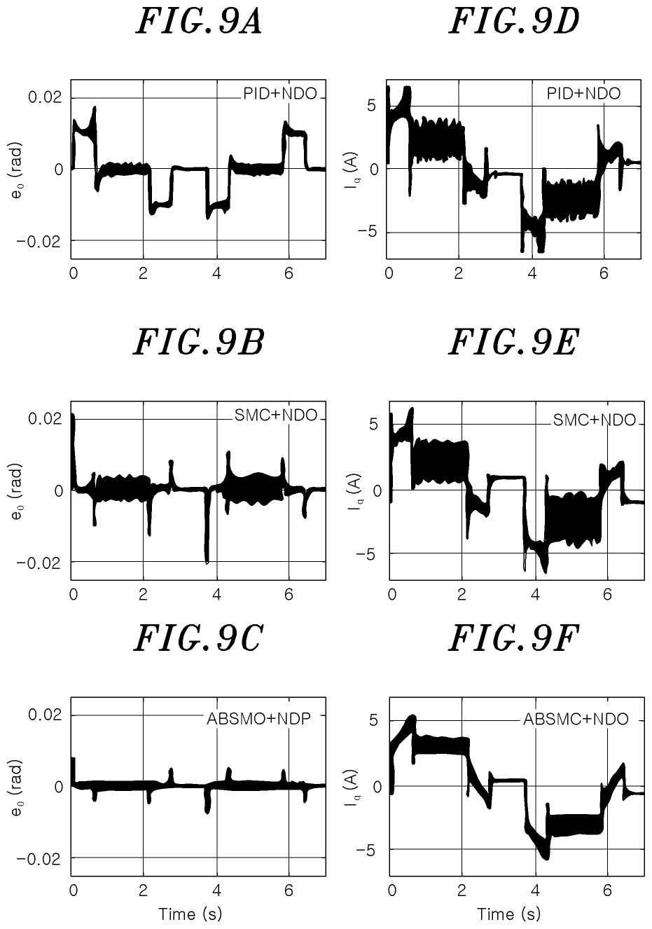

FIGS. 8 and 9 are experimental results from the motion profile of FIGS. 7A and 7B. FIGS. 8A to 8D are the result of combining NDO and LDO with ABSMC, and FIGS. 8A and 8B illustrate the position errors between ABSMC and NDO and ABSMC and LDO.

It can be confirmed that NDO, which applied the proposed nonlinear observer gain function, obtained a steady-state position error of 0.0009 rad, which was superior to the result of LDO (0.0016 rad).

Additionally, the performance of the proposed method was tested by combining NDO with PID, SMC, and the proposed ABSMC.

FIGS. 9A to 9F illustrate the results of PID+NDO, SMC+NDO, and ABSMC+NDO.

ABSMC+NDO has a maximum position error of 0.008 rad, while PID+NDO has a maximum error of 0.017 rad, and SMC+NDO has a maximum error of 0.021 rad, which is the best result.

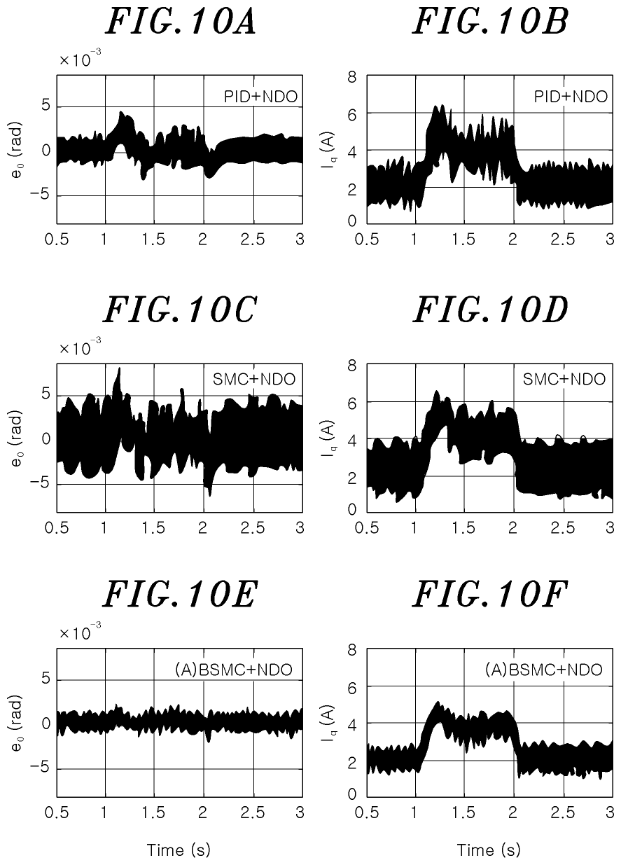

To check the robustness of the proposed method with respect to the sudden external load torque, an external load torque of 0.12 Nm was generated in 1 second, and the brake was controlled to release the load in 2 seconds. The position errors of motors using PID+NDO, SMC+NDO, and the proposed ABSMC+NDO are illustrated in FIGS. 10A to 10F. The proposed ABSMC+NDO method has superior performance in removing disturbances compared to other methods when a sudden external load torque occurs.

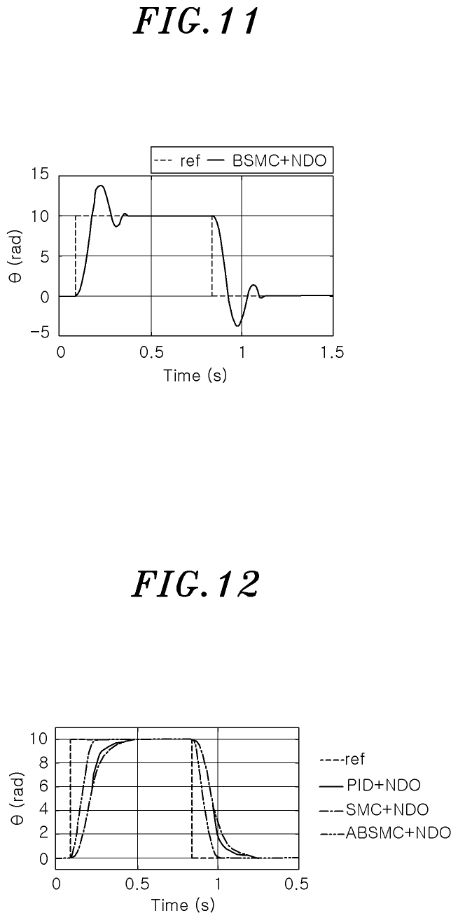

FIG. 12 illustrates the results of an experiment in a point-to-point position profile situation with the external load torque. An external load torque of 0.12 Nm was added during the step position profile, and the results are illustrated in FIGS. 11 and 12. ABSMC+NDO had a shorter settling time of 0.28 seconds compared to PID+NDO (0.72 seconds) and SMC+NDO (0.67 seconds), and compared to the fixed convergence gain in FIG. 11, the over-short was reduced.

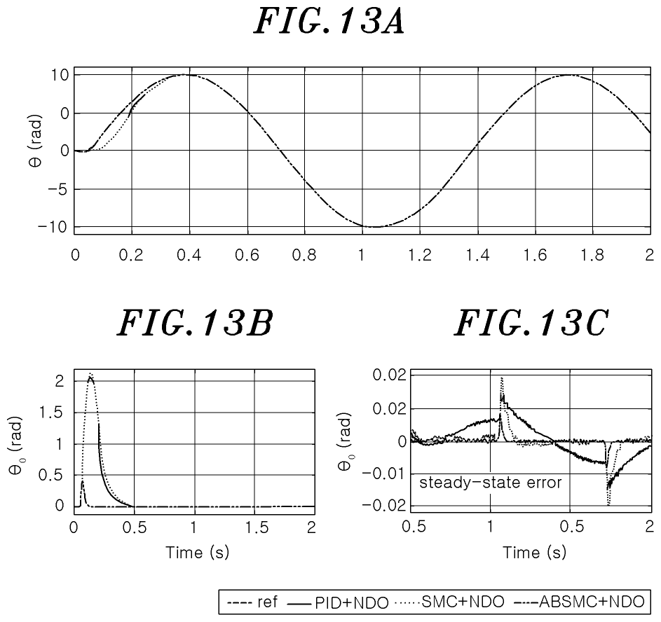

FIGS. 13A to 13C illustrate the results of an experiment at a sinusoidal position profile of 10 sin (1.5 πt) with the external load torque of 0.12 Nm. In the PID+NDO, the maximum error was 2.08 rad, the settling time was 0.6 s, and the maximum steady-state error was 0.015 rad. In the SMC+NDO, the maximum error is 2.14 rad, the settling time is 0.6 s, and the maximum steady-state error is 0.02 rad.

Meanwhile, the proposed ABSMC+NDO was found to have a maximum error of 0.43 rad, a setting time of 0.16 s, and a maximum steady-state error of 0.009 rad. These results prove that the ABSMC+NDO method has better performance in improving PMSM position tracking than the PID+NDO, SMC+NDO, and BSMC+NDO methods.

According to the embodiment of the present disclosure as described above, a control technology to improve the position tracking control performance of the permanent magnet synchronous motor was implemented. Specifically, 1) the position current single loop control is possible by combining back-stepping and SMC methods, which is a non-cascade controller that simplifies the controller structure. 2) The motor achieves reliable control performance, fast response speed, reduced position steady-state error, and robustness to disturbances of unknown motor drivers in the trapezoidal velocity motion profile, the step profile, and the sinusoidal profile compared to PID and SMC methods (reduced position error when moving with a trapezoidal velocity profile, reduced settling time and overshoot when moving with a position step profile, reduced steady-state error when moving with a sinusoidal profile, or the like). 3) Compared to PID and SMC methods, the influence of internal parameter changes and external load torque of the motor system can be reduced.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. An apparatus for controlling a permanent magnet synchronous motor in a permanent magnet synchronous motor system, the apparatus comprising:
a disturbance observation circuit unit configured to estimate concentrated disturbance of the permanent magnet synchronous motor using a nonlinear observation gain function; and
a sliding mode controller configured to control the permanent magnet synchronous motor by reflecting the estimated concentrated disturbance in a position-current single-loop control in which back-stepping control and sliding mode control are integrated.

2. The apparatus of claim 1, wherein the sliding mode controller is configured to receive a signal including a reference current of a Direct-axis (D-axis) and reference position information of a rotor of the permanent magnet synchronous motor.

3. The apparatus of claim 2, wherein the reference current of the D-axis is set to 0.

4. The apparatus of claim 1, wherein the sliding mode controller is configured to control a current of a Quadrature-axis (Q-axis) and a current of the D-axis of the permanent magnet synchronous motor system.

5. The apparatus of claim 1, wherein the disturbance observation circuit unit is configured to calculate a derivative of the concerned disturbance and input the derivative to the sliding mode controller.

6. The apparatus of claim 1, wherein the permanent magnet synchronous motor system includes a space vector pulse width modulator configured to convert a two-axis rotating system into a two-axis stationary system and determine a pulse width modulation signal for an inverter switch to generate a three-phase voltage required by the permanent magnet synchronous motor system.

7. The apparatus of claim 1, wherein the back-stepping control includes a control for an adaptive convergence gain to prevent overshoot.

8. The apparatus of claim 1, wherein the nonlinear observation gain function includes a nonlinear design function combining a primary state variable and a second state variable.

9. The apparatus of claim 1, wherein the sliding mode controller includes an adaptive back-stepping sliding mode controller.

10. The apparatus of claim 1, wherein the disturbance observation circuit unit includes a nonlinear disturbance observer circuit unit.

11. A method for controlling a permanent magnet synchronous motor in a permanent magnet synchronous motor system by a control unit in a permanent magnet synchronous motor system, the method comprising:
calculating an adaptive convergence gain, position error, and a first virtual control signal by the control unit when an input signal is input to the permanent magnet synchronous motor in the permanent magnet synchronous motor system;
calculating a first difference between the first virtual control signal and an actual control signal and calculating a second virtual control signal based on the first difference and a concentrated disturbance of the permanent magnet synchronous motor system estimated by a nonlinear disturbance observer circuit unit;
calculating a second difference between the second virtual control signal and the actual control signal and calculating a first sliding-mode surface function and a voltage control signal of a Quadrature-axis (Q-axis) based on the second difference; and
calculating a third difference between a third virtual control signal based on the voltage control signal of the Q-axis and the actual control signal and calculating a second sliding-mode surface function and a voltage control signal of a Direct-axis (D-axis) based on the third difference.

12. The method of claim 11, wherein the input signal includes a reference current of the D-axis and reference position information of a rotor of the permanent magnet synchronous motor.

13. The method of claim 11, wherein the control unit is configured to control a current of the Q-axis coordinate system and a current of the D-axis of the permanent magnet synchronous motor system.

14. The method of claim 11, wherein the nonlinear disturbance observation circuit unit is configured to estimate the concentrated disturbance of the permanent magnet synchronous motor using nonlinear observation gain function, provide the concentrated disturbance of the permanent magnet synchronous motor system to the control unit, calculate a derivative of the concerned disturbance, and input the derivative of the concerned disturbance to the control unit.

15. The method of claim 11, wherein the permanent magnet synchronous motor system includes a space vector pulse width modulator configured to convert a two-axis rotating system into a two-axis stationary system and determine a pulse width modulation signal for an inverter switch to generate a three-phase voltage required by the permanent magnet synchronous motor system.

16. The method of claim 11, wherein the control unit is configured to control the permanent magnet synchronous motor system by integrating back-stepping control and sliding mode control, and
wherein the back-stepping control includes a control for an adaptive convergence gain to prevent overshoot.

17. The method of claim 14, wherein the nonlinear observation gain function includes a nonlinear design function combining a primary state variable and a second state variable.

18. The method of claim 12, wherein the position error is calculated by a difference between the reference position information and the actual control signal.

19. The method of claim 11, wherein the calculating the second virtual control signal includes calculating a nominal virtual control signal without considering uncertainty and an external load torque.

20. A non-transitory computer readable storage medium storing computer executable instructions, wherein the instructions, when executed by a processor, cause the processor to perform a method for controlling a permanent magnet synchronous motor in a permanent magnet synchronous motor system, the method comprising:
calculating an adaptive convergence gain, position error, and a first virtual control signal by the control unit when an input signal is input to the permanent magnet synchronous motor in the permanent magnet synchronous motor system;
calculating a first difference between the first virtual control signal and an actual control signal and calculating a second virtual control signal based on the first difference and a concentrated disturbance of the permanent magnet synchronous motor system estimated by a nonlinear disturbance observer circuit unit;
calculating a second difference between the second virtual control signal and the actual control signal and calculating a first sliding-mode surface function and a voltage control signal of a Quadrature-axis (Q-axis) based on the second difference; and
calculating a third difference between a third virtual control signal based on the voltage control signal of the Q-axis and the actual control signal and calculating a second sliding-mode surface function and a voltage control signal of a Direct-axis (D-axis) based on the third difference.
